(19) United States
(12) Patent Application Publication
(10) Pub. No.: US 2008/0121271 A1
(43) Pub. Date: May 29, 2008

(54) MULTI-JUNCTION, PHOTOVOLTAIC DEVICES WITH NANOSTRUCTURED SPECTRAL ENHANCEMENTS AND METHODS THEREOF

(75) Inventors: Ryne P. Raffaelle, Honeoye Falls, NY (US); David M. Wilt, Bay Village, OH (US)

Correspondence Address: NIXON PEABODY LLP - PATENT GROUP, 1100 CLINTON SQUARE, ROCHESTER, NY, 14604, US

(73) Assignees: ROCHESTER INSTITUTE OF TECHNOLOGY, Rochester, NY (US); GLENN RESEARCH CENTER, Cleveland, OH (US)

(21) Appl. No.: 11/744,021

(22) Filed: May 3, 2007

Related U.S. Application Data
(60) Provisional application No. 60/797,152, filed on May 3, 2006.

(51) Int. Cl. H02N 6/00

(52) U.S. Cl. 136/248; 136/244; 136/246; 977/774

(57) ABSTRACT

A photovoltaic device includes three or more solar cells which are layered on top of each other, at least one of quantum dots and quantum dashes, and first and second conductors. The quantum dots or quantum dashes are incorporated in at least one of the solar cells which is between the other solar cells. The first conductor is coupled to one of the solar cells and the second conductor is coupled to another one of the solar cells.

This application claims the benefit of U.S. Provisional Patent Application Ser. No. 60/797,152, filed May 3, 2006, which is hereby incorporated by reference in its entirety.

This invention was made with Government support under Grant No. NAG3-2595, awarded by National Aeronautics and Space Administration, Glen Research Center. The U.S. Government may have certain rights.

### FIELD OF THE INVENTION

The present invention generally relates to photovoltaic devices and, more particularly, to multi-junction, photovoltaic devices with nanostructured spectral enhancements and methods thereof.

### BACKGROUND

Basically, a photovoltaic device or solar cell has a large-area p-n junction diode which is capable of generating usable electrical energy from solar light. This conversion of solar light into electrical energy is called the photovoltaic effect. Typically, this photovoltaic device consists of triple junction solar cells. Unfortunately, the efficiencies of these photovoltaic devices have been less than ideal.

To improve energy conversion efficiency, prior photovoltaic devices have attempted to use lattice-matched materials and also have tried to make adjustments to individual cell thickness. Although these efforts improved the performance of these prior photovoltaic devices, optimum results still have not been obtained.

Other attempts to improve energy conversion efficiency have focused on obtaining a more optimized set of bandgaps in the photovoltaic device by adjusting the compositions of the p-n junction diodes and by growing lattice mismatched materials. However, again although these efforts improved the performance of these prior photovoltaic devices, the results have been less than optimal.

Recently, four p-n junction and even five p-n junctions stacks have been developed to attempt to improve efficiencies in photovoltaic devices. However, again these attempts in improving overall cell efficiency have been unsuccessful.

### SUMMARY

A photovoltaic device in accordance with embodiments of the present invention includes three or more solar cells which are layered on top of each other, at least one of quantum dots and quantum dashes, and first and second conductors. The quantum dots or quantum dashes are incorporated in at least one of the solar cells which is between the other solar cells. The first conductor is coupled to one of the solar cells and the second conductor is coupled to another one of the solar cells.

A method for making a photovoltaic device in accordance with other embodiments of the present invention includes forming three or more solar cells on top of each other. At least one of quantum dots and quantum dashes are incorporated in at least one of the solar cells which is between the other solar cells. A first conductor is coupled to one of the solar cells and a second conductor is coupled to another one of the solar cells.

A method for converting radiation into electrical energy in accordance with other embodiments of the present invention includes absorbing radiation with three or more solar cells which are layered on top of each other. At least one of quantum dots and quantum dashes are incorporated in at least one of the solar cells which is between the other solar cells. The three or more solar cells convert at least a portion of the absorbed radiation into electrical energy. The electrical energy is output with a first conductor coupled to one of the solar cells and a second conductor coupled to another one of the solar cells.

The present invention provides a more efficient and effective photovoltaic device for converting solar light and other radiation into usable electrical energy using substantially lattice-matched growth. Additionally, the present invention can tune the photovoltaic device for particular radiation spectrums by incorporating quantum dots or quantum dashes. Further, the present invention is highly suitable for use in extreme environments, such as space.

### BRIEF DESCRIPTION OF THE DRAWINGS

FIG. 1 is a partially perspective and partially cross sectional view of a photovoltaic device in accordance with embodiments of the present invention;

FIG. 2 is a graph of lattice constant versus energy gaps for Group III-V materials with a dashed arrow indicating a lattice matched triple-junction cell on Ge;

FIG. 3 is a graph of wavelength/nm versus irradiance for the solar spectrum with shading corresponding to the regions converted via each individual junction (Y=top junction, X=middle junction); and

FIG. 4 is a graph of theoretical efficiency contours based on the middle and top cell bandgaps with realistic fill factors.

### DETAILED DESCRIPTION

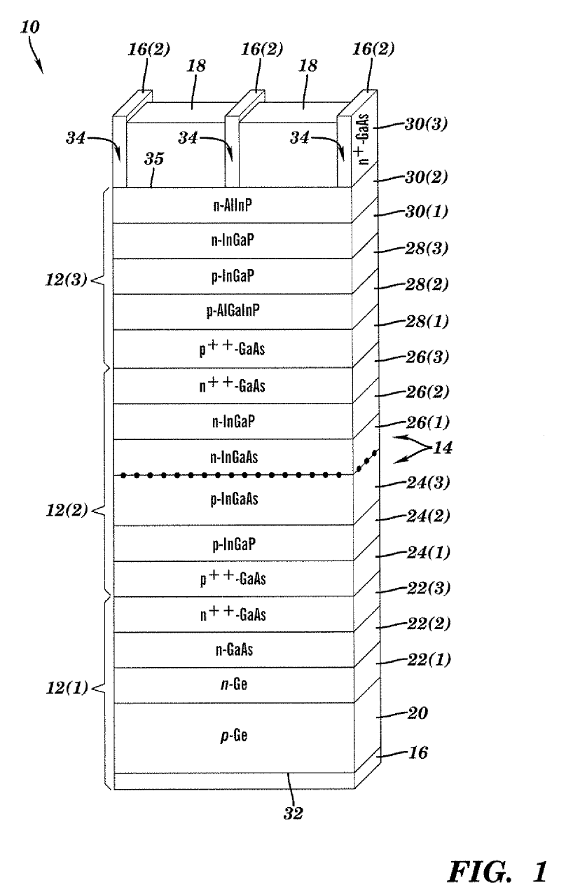

A photovoltaic device 10 in accordance with embodiments of the present invention is illustrated in FIG. 1. The photovoltaic device 10 includes solar cells 12(1)-12(3), quantum dots 14, conductors 16(1)-16(2), and anti-reflective coating 18, although the device 10 can include other types and numbers of layers, components, devices, and/or systems configured in other manners. The present invention provides a number of advantages including providing a more efficient and effective photovoltaic device for converting solar light and other radiation into usable electrical energy.

Referring more specifically to FIG. 1, the photovoltaic device 10 comprises three solar cells 12(1)-12(3) which are layered on top of each other with connecting tunnel junctions in between, although the photovoltaic device 10 can comprise other numbers and types of solar cells, layer, components, devices, and systems in other configurations. In this particular embodiment, each of the solar cells 12(1)-12(3) is formed to absorb a substantially different spectrum of radiation to convert to electrical energy, although the solar cells could be formed to have other absorption characteristics.

The solar cell 12(1) comprises an n^{||} type GaAs layer 22(3) on an n type GaAs layer 22(2) on an n type Ge layer 22(1) on a p type Ge layer 20, although solar cell 12(1) could comprise other numbers and types of n type layers and p type layers made of other materials in other configurations. The solar cell 12(2) comprises an n⁺⁺ type GaAs layer 26(3) on an n type InGaP layer 26(2) on an n type InGaAs layer 26(1) on a p type InGaAs layer 24(3) on a p type InGaP layer 24(2) on a p^{||} GaAs layer 24(1), although solar cell 12(2) could comprise other numbers and types of n type layers and p type layers made of other materials in other configurations. The solar cell 12(3) comprises an n⁺ type GaAs layer 30(3) which has been etched to form three sections on an n type AlInP layer 30(2) on an n type InGaP layer 30(1) on a p type InGaP layer 28(3) on a p type AlGaInP layer 28(2) on a p⁺⁺ GaAs layer 28(1), although solar cell 12(3) could comprise other numbers and types of n type layers and p type layers made of other materials in other configurations. Each of the n type layers and p-type layers of the three or more solar cells 12(1)-13(3) are substantially lattice matched with the adjacent n type layers and p type layers to provide efficient operation and low defect-densities.

A plurality of quantum dots of substantially the same size are incorporated in the junction area between n type layer InGaAs 26(1) and the p type InGaAs layer 24(3) in solar cell 12(2), although the quantum dots or dashes can be on other locations. The presence of quantum dots or dashes lowers the effective bandgap of the middle solar cell 12(2) of solar cells 12(1)-12(3) which improves the short circuit current in solar cell 12(2) resulting in an overall improvement in conversion efficiency.

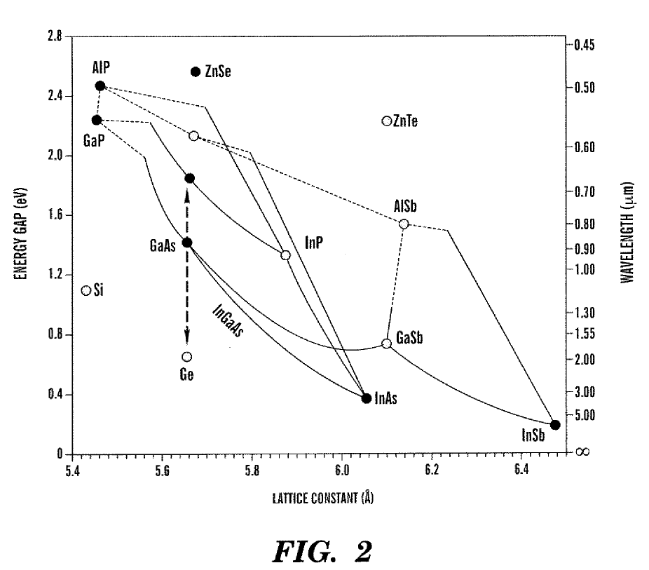

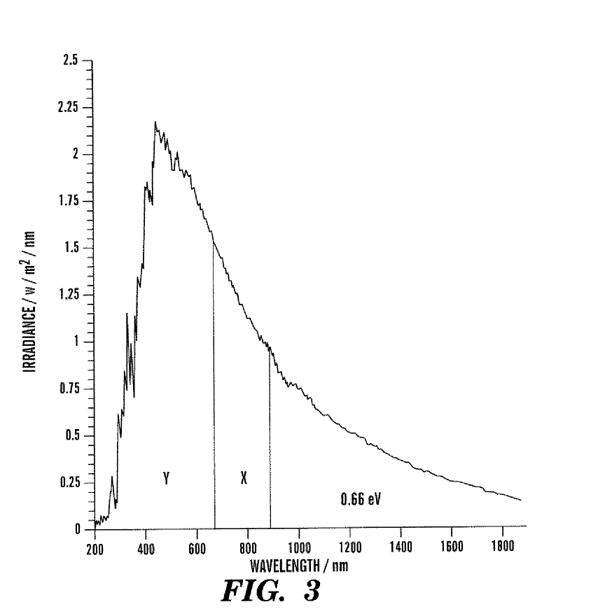

As shown in FIG. 2, a conventional lattice-matched approach to multi-junction solar cell development puts a constraint on the available bandgaps and therefore the solar spectrum is divided between the junctions as shown in FIG. 3.

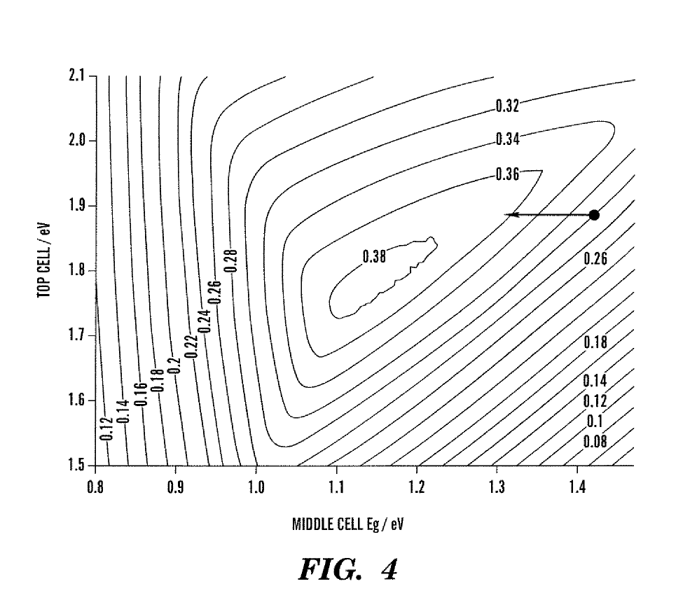

Referring to FIG. 4, theoretical efficiency contours based on the middle and top cell bandgap combinations based upon measured efficiencies are shown. The material properties associated with the wide bandgap top junctions are not conducive to high efficiency devices. The black dot in FIG. 4 indicates the current efficiency of a conventional photovoltaic device. The black arrow in FIG. 4 indicates improvement which is possible with the present invention by lowering the effective bandgap of the middle junction in the triple junction solar cell. Lowering the effective bandgap of the middle junction results in an overall improvement in efficiency by improving the middle cell's short-circuit current. By way of example only, with the present invention the efficiency of the photovoltaic device 10 is improved by over 40% when compared to prior photovoltaic devices. The use of quantum dots and quantum dashes in the solar cell 12(2) of the photovoltaic device 10 also enables the present invention to effectively lower the middle junction bandgap while still adhering to the “rules” of normal lattice-matched growth.

The use of quantum dots in the solar cell 12(2) in photovoltaic device 10 also provides improved temperature coefficients and better radiation tolerance. As a result, the photovoltaic device 10 is more suitable for operation in extreme environments, such as space.

Referring back to FIG. 1, a conductive contact 16(1) is coupled to an outer surface 32 of p type Ge layer 20 for solar cell 12(1) and another conductive contact 16(2) has three sections which are coupled to an outer surface 34 of the three sections of n⁺ GaAs layer 30(3) for solar cell 12(3), although other numbers and types of conductive contacts which are coupled to one or more of the solar cells 12(1)-12(3) in other locations can be used. The conductive contacts 16(1)-16(2) are made of alloys of gold and/or silver, although other types of conductive materials could be used.

An anti-reflective coating 18 is located on a portion of the outer surface 35 of n type AlInP layer 30(2) for solar cell 12(3), although other numbers and types of coatings in other locations, such as a partially anti-reflective coating could be used. The anti-reflective coating 18 helps with the absorption of the radiation into the solar cells 12(1)-12(3).

A method for making the photovoltaic device 10 in accordance with embodiments of the present invention will now be described with reference to FIG. 1. The solar cells 12(1)-12(3) are sequentially formed on each other, although other numbers and types of solar cells could be formed.

More specifically, in this particular embodiment: an n type Ge layer 22(1) is formed by diffusion of arsenic from the OMVPE growth ambient into a p type Ge layer 20; an n type GaAs layer 22(2) is epitaxially grown on the n type Ge layer 22(1); an n⁺⁺ type GaAs layer 22(3) is epitaxially grown on n type GaAs layer 22(2) to form the solar cell 12(1), although solar cell 12(1) could be formed in other manners and could comprise other numbers and types of n type layers and p type layers made of other materials in other configurations.

Next, in this particular embodiment: a p⁺⁺ GaAs layer 24(1) for solar cell 12(2) is epitaxially grown on n⁺⁺ type GaAs layer 22(3) for solar cell 12(1); a p type InGaP layer 24(2) is epitaxially grown on the p⁻⁺ GaAs layer 24(1); a p type InGaAs layer 24(3) is epitaxially grown on the p type InGaP layer 24(2); an n type InGaAs layer 26(1) is epitaxially grown on p type InGaAs layer 24(3); an n type InGaP layer 26(2) is epitaxially grown on the n type InGaAs layer 26(1); and an n⁻⁺ type GaAs layer 26(3) is epitaxially grown on the n type InGaP layer 26(2), although solar cell 12(2) could be formed in other manners and could comprise other numbers and types of n type layers and p type layers made of other materials in other configurations.

The quantum dots are introduced into the junction area between n type layer InGaAs 26(1) and the p type InGaAs layer 24(3) in solar cell 12(2) during the growth of the materials which make up the n type layer InGaAs 26(1) and the p type InGaAs layer 24(3) in solar cell 12(2), although the quantum dots can be formed in other areas and in other solar cells and can be formed in other manners at other times. These quantum dots 14 provide sub-gap absorption and thus improve the short-circuit current of the junction in solar cell 12(2). By adjusting the size of the quantum dots being formed, the photovoltaic device 10 can be tuned to a variety of solar or other spectral distributions.

In this particular embodiment, the materials for the quantum dots 14 are produced using an epitaxial crystal growth process, such as metal organic chemical vapor deposition (MOCVD), organometallic vapor deposition (OMVPE), or molecular beam epitaxy (MBE) by way of example only. The particular material used for the quantum dot materials used depends upon the host semiconductor in the solar cell 12(2). By way of example only, these materials for the quantum dots may include InAs, GaAs, InP, InSb, GaSb, and GaP.

Next, in this particular embodiment: a p⁺⁺ GaAs layer 28(1) for solar cell 12(3) is epitaxially grown on n⁺⁺ type GaAs layer 26(3) for solar cell 12(2); a p type AlGaInP layer 28(2) is epitaxially grown on the p⁺⁺ GaAs layer 28(1); a p type InGaP layer 28(3) is epitaxially grown on the p type AlGaInP layer 28(2); an n type InGaP layer 30(1) is epitaxially grown on the p type InGaP layer 28(3); an n type AlInP layer 30(2)is epitaxially grown on the n type InGaP layer 30(1); an n^{|} type GaAs layer 30(3) is epitaxially grown on the n type AlInP layer 30(2) and is then etched into three sections to expose portions of the n type AlInP layer 30(2), although solar cell 12(2) could comprise other numbers and types of n type layers and p type layers made of other materials in other configurations and manners. Each of the n type layers and p-type layers of the three or more solar cells 12(1)-13(3) described above are epitaxially grown to be substantially lattice matched with the adjacent n type layers and p type layers to provide efficient operation and low defect-densities.

Next, the conductive contact 16(1) is deposited on a portion of the surface 32 of the p type Ge layer 20 for solar cell 12(1), although the conductive contact could be formed in other manners. Additionally, the conductive contact 16(2) is deposited and etched into three sections on three sections of surface 34 of n⁺ type GaAs layer 30(3), although this conductive contact also could be formed in other manners. An anti-reflective coating 18 is also deposited on a portion of surface 35 of n type AlInP layer 30(2), although this anti-reflective coating also could be formed in other manners.

The operation of the photovoltaic device 10 in accordance with embodiments of the present invention will now be described with reference to FIG. 1. The solar cells 12(1)-12(3) through the anti-reflective coating 18 are exposed to solar light to be converted to electrical energy, although the solar cells 12(1)-12(3) could be exposed to other types and amounts of radiation energy for conversion to electrical energy in other manners. This solar light is absorbed and converted by the solar cells 12(1)-12(3) into electrical energy. In this particular embodiment, each of the solar cells 12(1)-12(3) absorbs and converts a substantially different spectrum of radiation to electrical energy, although the solar cells 12(1)-12(3) could have other absorption characteristics. Next, this electrical energy is output via conductive contacts 16(1)-16(2), although the electrical energy could be output in other manners.

Accordingly, the present invention provides a more efficient and effective photovoltaic device for converting solar light and other radiation into usable electrical energy. The present invention has a number of uses including to improve solar cell performance, solar cell thermal performance, and solar cell radiation resistance. Through the use of arrays of quantum dots, the present invention allows for the tuning of the individual bandgaps in solar cells 12(1)-12(3) to improve the overall conversion efficiency of the photovoltaic device. Further, the present invention allows for the photoconversion of light to electrical energy of long-wavelength sub-bandgap photons that would be normally inaccessible to the conventional pn junction solar cell.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A photovoltaic device comprising:
three or more solar cells which are layered on top of each other;
at least one of quantum dots and quantum dashes incorporated in at least one of the solar cells which is between the other solar cells;
a first conductor coupled to one of the solar cells; and
a second conductor coupled to another one of the solar cells.

2. The device as set forth in claim 1 wherein each of the solar cells comprises one of one or more n type layers and one or more p type layers on the other one of one or more n type layers and one or more p type layers.

3. The device as set forth in claim 2 wherein the at least one of quantum dots and quantum dashes are incorporated in the one of one or more n type layers and one or more p type layers and in the other one of the one or more of one or more n type layers and one or more p type layers in at least one of the solar cells.

4. The device as set forth in claim 2 wherein each of the n type layers and p-type layers of the three or more solar cells are substantially lattice matched with the adjacent n type layers and p type layers.

5. The device as set forth in claim 4 wherein a bandgap of the solar cell with the at least one of quantum dots and quantum dashes is less than a bandgap of at least one of the other solar cells.

6. The device as set forth in claim 1 wherein each of the three or more solar cells absorb a substantially different spectrum of radiation.

7. The device as set forth in claim 1 further comprising at least a partially, anti-reflective coating on an outer surface of one of the solar cells.

8. A method for making a photovoltaic device, the method comprising:
forming three or more solar cells on top of each other;
incorporating at least one of quantum dots and quantum dashes in at least one of the solar cells which is between the other solar cells;
providing a first conductor coupled to one of the solar cells; and
providing a second conductor coupled to another one of the solar cells.

9. The method as set forth in claim 8 wherein the forming three or more solar cells further comprises forming for each of the solar cells one of one or more n type layers and one or more p type layers on the other one of one or more n type layers and one or more p type layers.

10. The method as set forth in claim 9 wherein the incorporating at least one of quantum dots and quantum dashes in at least one of the solar cells further comprises incorporating the at least one of quantum dots and quantum dashes in the one of one or more n type layers and one or more p type layers and in the other one of the one or more of one or more n type layers and one or more p type layers in at least one of the solar cells.

11. The method as set forth in claim 9 wherein the forming for each of the solar cells further comprises forming each of the n type layers and p-type layers to be substantially lattice matched with the adjacent n type layers and p type layers.

12. The method as set forth in claim 11 wherein the forming three or more solar cells further comprises forming at least one of the solar cells with the at least one of quantum dots and quantum dashes to have a bandgap which is less than a bandgap of at least one of the other solar cells.

13. The method as set forth in claim 8 wherein the forming three or more solar cells further comprises forming each of the three or more solar cells to absorb a substantially different spectrum of radiation.

14. The method as set forth in claim 8 further comprising forming at least a partially, anti-reflective coating on an outer surface of one of the solar cells.

15. A method for converting radiation into electrical energy, the method comprising:
absorbing radiation with three or more solar cells which are layered on top of each other, at least one of quantum dots and quantum dashes are incorporated in at least one of the solar cells which is between the other solar cells;
converting with the three or more solar cells at least a portion of the absorbed radiation into electrical energy; and
outputting the electrical energy with a first conductor coupled to one of the solar cells and a second conductor coupled to another one of the solar cells.

16. The method as set forth in claim 15 wherein each of the solar cells comprises one of one or more n type layers and one or more p type layers on the other one of one or more n type layers and one or more p type layers.

17. The method as set forth in claim 16 wherein the at least one of quantum dots and quantum dashes are incorporated in the one of one or more n type layers and one or more p type layers and in the other one of the one or more of one or more n type layers and one or more p type layers in at least one of the solar cells.

18. The method as set forth in claim 16 wherein each of the n type layers and p-type layers of the three or more solar cells are substantially lattice matched with the adjacent n type layers and p type layers.

19. The method as set forth in claim 18 wherein a bandgap of the solar cell with the at least one of quantum dots and quantum dashes is less than a bandgap of at least one of the other solar cells.

20. The method as set forth in claim 15 wherein the absorbing radiation with three or more solar cells further comprises absorbing a substantially different spectrum of radiation with each of the three or more solar cells.

21. The method as set forth in claim 15 wherein an outer surface of one of the solar cells has at least a partially, anti-reflective coating.
